(19) United States
(12) Patent Application Publication
(10) Pub. No.: US 2017/0142958 A1
(43) Pub. Date: May 25, 2017

(54) Single Use Scent Masking System for Hunting Environment Maintenance

(71) Applicants: Michael Lee McDaniel, Keller, TX (US); Gary McDaniel, Rockwall, TX (US)

(72) Inventors: Michael Lee McDaniel, Keller, TX (US); Gary McDaniel, Rockwall, TX (US)

(21) Appl. No.: 14/950,196

(22) Filed: Nov. 24, 2015

(51) Int. Cl. A01M 31/00; A41D 13/00; A43B 1/00; A41D 19/00; A43B 3/16

(52) U.S. Cl. CPC A01M 31/00; A41D 19/0006; A43B 3/16; A43B 1/0045; A41D 13/0015; A41D 2400/36

(57) ABSTRACT

A scent masking kit for maintenance of a hunting environment. The hunter, before entering into the hunting environment opens an airtight sealed package and dons scent masking gloves and shoe covers contained therein, wipes masking scents on the contact surfaces of the gloves and shoe covers, and enters the hunting environment temporarily to maintain the area's equipment, and uses a kneeling pad when working close to the ground to avoid leaving human scent in the environment. Upon leaving the area, the hunter disposes of the kit components and thus is prevented from contaminating the hunting environment with human scents which may repel the wildlife.

### BACKGROUND OF THE INVENTION

When hunting game animals, such as deer, it has been found that the natural human odors/scents inherent to the hunter can be detected by the animal, which causes the animal to avoid the area. Many scented substances have been developed to camouflage human odors from animal detection. Such substances are typically applied directly to the clothes worn by the hunter and serve to mask the human scent during the hunt.

In additional efforts to get rid of scent, many hunters bathe in special unscented soaps before dressing in clothing washed in scent free detergent. This whole effort is made to prevent the human odor from being detected in the air while the hunter is in the area.

Hunters often set up feeders to attract game to specific areas. They also use motion sensitive cameras to capture and analyze activity in the area. These devices must be monitored and serviced on a regular basis. Hunters are often reluctant to undertake the lengthy process to de-scent their bodies and clothing for the few minutes necessary to service the feeder and/or cameras.

While the regular scent of a human permeating the air may quickly dissipate, contact points leave scent in the surroundings which affect animal behavior. What is desired is a quick and easy means of avoiding deposits of human scent through contact without the extensive cleaning and maintenance currently required of scent masking methods which are too extensive and time consuming for minor maintenance activities on a hunting area.

It should be noted that use of the term hunting throughout this disclosure is meant to encompass all activities of promoting interaction between humans and wildlife. It may be for purposes of photography, environmental study, or other activities, in addition to the traditional definition of sport or subsistence taking of game.

### BRIEF DESCRIPTION OF THE DRAWINGS

FIG. 1 illustrates a use in a typical environment in accordance with an exemplary embodiment of the invention.

FIG. 2 shows a glove in accordance with an exemplary embodiment of the invention.

FIG. 3 shows a shoe cover in accordance with an exemplary embodiment of the invention.

FIG. 4 shows a maintenance package in accordance with an exemplary embodiment of the invention.

### DETAILED DESCRIPTION OF THE PREFERRED EMBODIMENTS

Described herein is a disposable scent masking package comprising scent retaining gloves and/or shoe covers which have externally a masking scent that is deposited into the environment as residue from contact. In addition, a scent applicator may be packaged therewith and applied to the environment or items to be left therein. The innovation comprises gloves and shoe covers which retain human scent and deposit an additional masking scent on contact with the environment as a residue. This masking scent may be a feed scent or an animal scent to further attract wildlife; or other natural scents to further mask the human scents of the wearer.

Additionally, a kneeling pad may be utilized when other body parts besides hands and feet must come in contact with the environment, such as when kneeling to work close to the ground, or when bracing or leaning against a tree or other environmental object.

In the preferred embodiment, the gloves and/or shoe covers are externally pre-scented with a masking scent which is deposited as a faint residue where the scent retaining devices contact the environment. In this embodiment, the scent retaining devices may be scented during the manufacturing process, or prior to packaging. In another embodiment, the devices may be scented with the scent applicator at time of use, and re-scented periodically throughout use as needed.

The principal contact areas are the feet during traversal of the area, and the hands during manipulation of the devices and environment. This may include walking to and from the desired location, traversing the area to observe signs of activity, or to view different angles for later hunting trips. Other body parts seldom need to contact the environment, but use of a kneeling pad will prevent direct contact in such situations where it is necessary.

Manipulation and maintenance of the devices may include, but not be limited to, repositioning cameras, retrieving or downloading camera memory cards, filling feeders, setting timers, and moving or cutting brush and branches. This activity is hereinafter referred to generally as maintenance of the environment.

Gloves and shoe covers are made of a material which cover the hands and feet, the contact areas, and prevent transfer of human scents during maintenance of the environment. This allows the maintainer to walk to the area, manipulate/service the camera or feeder without leaving human scent on the devices to deter animals from entering the area. A kneeling pad further allows one to sit or kneel without direct contact with the environment.

In addition to preventing the transfer of human scents, the materials may be coated with other scents which are intentionally deposited to prevent detection of human interaction with the environment, and to further attract wildlife to the area. In one embodiment the other scents may be feed scent which attract wildlife such as, but not limited to, corn, oats, and acorns. In another embodiment the other scents may be neutralizing scents which are largely ignored by wildlife as being natural to the area such as, but not limited to, pine, earth, and decaying leaves. In another embodiment the other scents may be curiosity scents which attract wildlife such as pheromones, vanilla, skunk or other wildlife scents.

In one embodiment the gloves may be of a plastic or latex. The material must be sufficiently lightweight to allow tactile manipulation of components and control of the devices. The material must also be able to absorb and/or hold the masking scent so that it is only deposited as a residue over the length of use.

In one embodiment the gloves are made of a lightweight cloth material which is coated on the inside with a latex, plastic, or rubber-like coating to contain the perspiration, oils and other scent producing secretions of the hands. While the latex or plastic keeps scents inside the glove, the materials also produce their own scents which are not natural to the environment and could also repel wildlife. Therefore, the materials are only on the inside unless they are themselves porous enough to retain masking scent so that they may be impregnated with masking scent during the manufacturing and/or packaging process and that scent migrate to the surface of the materials throughout use.

The outer material may be a light woven cloth so that it may absorb and radiate masking scents such as, but not limited to, natural scents like earth, pine, oak, and/or attracting scents such as acorns, corn, oats, or animal pheromones.

In one embodiment the shoe covers are made of a similar lightweight cloth material and coated on the inside with materials similar to that used in the gloves. While the feet are in shoes, there are still human scents on the shoes which are picked up from walking in human habituated areas. The shoe cover absorbs scents that are present on the shoes, such as oils and fuel picked up from the floorboards of the vehicle, or scents from the home/work which are especially human in nature.

In one embodiment the materials utilized for the shoes may be a heavier material than that of the gloves to provide more durability walking in remote areas where wildlife is most likely to be encountered. In another embodiment the shoe cover is made of the same lightweight material, but has an additional coating or additional layers on the lower area to sustain the wear of walking and to prevent debris from tearing the fabric.

The coating may be the same latex, plastic, or rubber-like coating as is found on the inside of the gloves and may add a moisture barrier to the shoe cover. However, the outer layer of the shoe covering must be a material which can absorb and radiate scent applied by the scent applicator, or picked up from the ground while walking. A latex or plastic that radiates its own repelling scent would defeat the purpose of masking the human scent.

The shoe cover's lower side may further include texture to prevent slipping. The upper opening of the shoe cover may contain elastic so that it will grip to the ankle and/or top of the shoe. In another embodiment the upper opening may include a draw string or ties to allow it to be cinched tightly around the upper part of the shoe.

The kneeling pad is constructed in a similar manner to that of the shoe coverings, but is a flat, substantially rectangular shape approximately a shoulder's width in length. One skilled in the arts would appreciate that the specific size and shape of the pad is not limiting to the innovation described herein.

The preferred embodiment of the innovation comprises a sealed package with two disposable gloves, and two disposable shoe covers. Additionally, there may be a further enclosed scent applicator impregnated with one of a plurality of scents to further mask human scent, and/or to attract wildlife. In one embodiment the scent applicator is separately sealed from the contact devices, either in a separate bag, or in an additional packaging inside the sealed package containing the contact devices. This sealed package is air impenetrable and eliminates contamination by preventing the contents from absorbing surrounding scents.

The package is carried by the hunter until he leaves the human inhabited areas such as a road, camp, or vehicle, and gets near the hunting environment. Before entering the hunting environment, the hunter opens the package and places the shoe covers over his/her own shoes.

The hunter then places the gloves over his/her hands and finally opens the scent applicator packaging. The scent applicator can be wiped across the hands and feet if additional scent is desired. The kneeling pad and scent applicator are then carried by the hunter into the hunting environment. The hunter then maintains the hunting areas, utilizing the kneeling pad whenever body parts or clothing other than hands and feet may come in contact with the environment.

For instance, the kneeling pad may be utilized on the ground for kneeling when working under a feeder/spreader, or a low mounted camera. Additionally, the kneeling pad may be laid against a tree and leaned against when reaching around the tree rather than rubbing the hunter's body across the tree truck, and leaving contaminating scent which frightens wildlife. The hunter also uses the scent applicator to wipe the cameras, feeders, stands, etc., to cover the scents of other humans who may have been in the area.

After leaving the area, the hunter removes the shoes and gloves and disposes of them along with the scent applicator and packaging. Since the package is open to the environment, it will absorb the scents of a vehicle, cabin, etc., and thus will no longer be as effective at masking human scent.

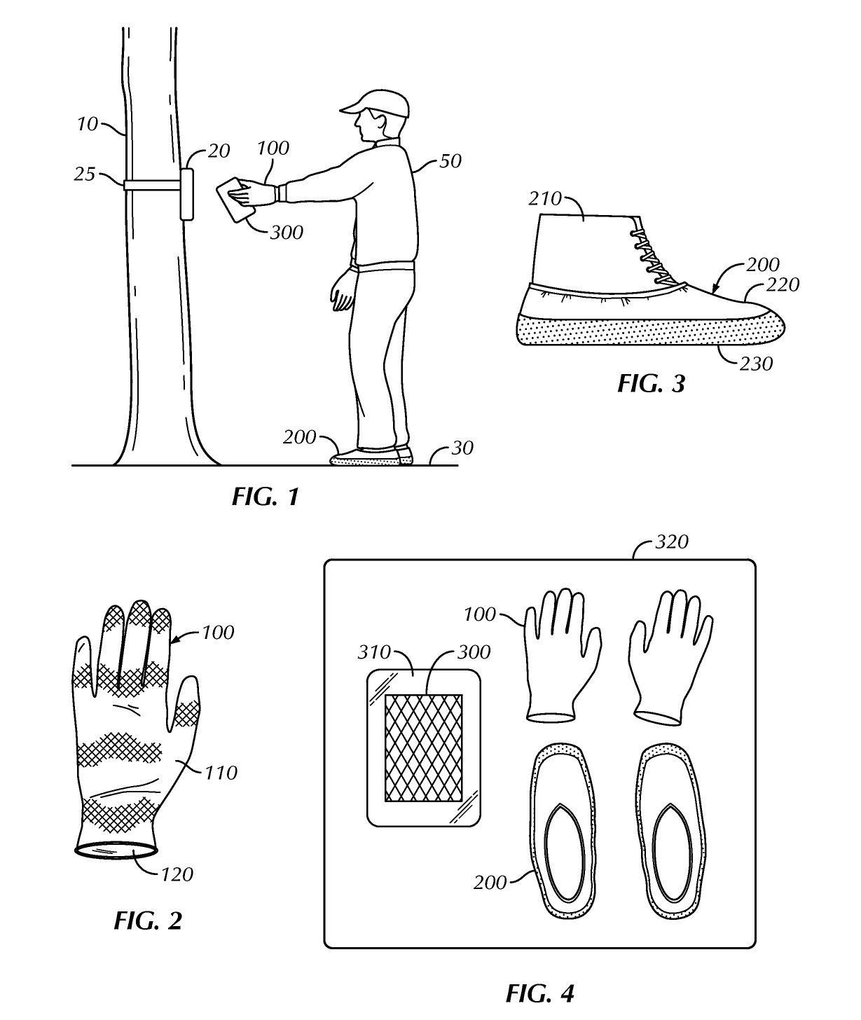

FIG. 1 illustrates a use in a typical environment in accordance with an exemplary embodiment of the invention. A hunter (50) approaches a wildlife camera (20) strapped (25) to a tree (10) in the environment without leaving human scent on the ground (30) because shoe covers (200) protect his shoes. Gloves (100) prevent his hands from leaving scent on the camera (20), and scent left by others may be masked by wiping with a scent applicator (300) from the maintenance kit.

FIG. 2 shows a glove in accordance with an exemplary embodiment of the invention. The glove (100) has a textured outer side (110) and a scent containing inner coating (120). The glove may be fitted or may be interchangeable between left and right hands. The outer coating holds a scent and deposits it freely with touch, while the inner coating retains scent on the inside of the glove during touching of the environment.

FIG. 3 shows a shoe cover in accordance with an exemplary embodiment of the invention. The shoe cover (200) has an upper portion (220) and a lower portion (230). The lower portion may be textured and/or water repellent or waterproof. The upper portion is secured to the lower portion of the shoe or boot (210) with a tie or elastic gathering (not labeled).

FIG. 4 shows a maintenance package in accordance with an exemplary embodiment of the invention. The package (not shown) is sealed to prevent odor absorption by the contents prior to opening and use. The contents of the package are a pair of gloves (100) and a pair of shoe covers (200), and a kneeling pad (320). The package may also include an optional scent applicator (300) which is additionally sealed (310) separate from the gloves (100) and shoe covers (200) until use.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in one form could actually vary in detail. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A scent masking device comprising gloves wherein the gloves retain the scent of the hands therein and are further scented externally with a masking scent that is deposited as a residue upon contact with the exterior surface of the device.

2. The scent masking device as described in claim 1 wherein the gloves are comprised of one or more layers of materials wherein one or more layers are non-porous on the inside and porous on the outside.

3. The scent masking device as described in claim 2 wherein at least one layer is a latex material.

4. The scent masking device as described in claim 2 wherein at least one layer is a plastic material.

5. The scent masking device as described in claim 2 wherein at least one layer is a fabric material.

6. A scent masking device comprising shoe covers wherein the covers retain the scent of the shoes/feet therein and are further scented externally with a masking scent that is deposited as a residue on the walking surface.

7. The scent masking device as described in claim 6 wherein the covers are comprised of one or more layers of materials wherein one or more layers are non-porous on the inside and porous on the outside.

8. The scent masking device as described in claim 7 wherein at least one layer is a latex material.

9. The scent masking device as described in claim 7 wherein at least one layer is a fabric material.

10. A scent masking kit comprising:
a pair of gloves;
a pair of shoe covers;
wherein the gloves and covers retain the scent of the user therein and are further scented externally with a masking scent that is deposited as a residue on contact.

11. The scent masking kit as described in claim 10 wherein the gloves and covers are comprised of one or more layers of materials, wherein one or more layers is non-pourous on the inside and porous on the outside.

12. The scent masking kit as described in claim 11 wherein at least one layer is a latex material.

13. The scent masking kit as described in claim 11 wherein at least one layer is a fabric material.

14. The scent masking kit as described in claim 10 further comprising:
a first sealed packaging containing the gloves and shoe covers in a scent isolated environment until use.

15. The scent masking kit, as described in claim 14 further comprising:
a scent applicator, enclosed in a second sealed packaging to retain a pre-deposited scent on the scent applicator, the second sealed packaging being contained within the first sealed packaging.

16. The scent masking kit, as described in claim 10 further comprising:
a kneeling pad.

17. The scent masking kit, as described in claim 10 wherein the gloves and covers comprise a light woven fabric exterior and a scent retaining plastic interior.

18. The scent masking kit, as described in claim 17 wherein the scent retaining interior comprises a flexible impermeable coating layered on the interior of the exterior fabric.

19. The scent masking kit, as described in claim 10 wherein the masking scent is an attracting scent.

20. The scent masking kit, as described in claim 10 wherein the masking scent is a neutralizing scent.
